(19) United States
(12) Patent Application Publication
(10) Pub. No.: US 2013/0157570 A1
(43) Pub. Date: Jun. 20, 2013

(54) MONITORING SYSTEM AND METHOD FOR A MOBILE DEVICE

(71) Applicants: CHIA-HUNG CHIU, Tu-Cheng (TW); YU-AN CHUNG, Tu-Cheng (TW)

(72) Inventors: CHIA-HUNG CHIU, Tu-Cheng (TW); YU-AN CHUNG, Tu-Cheng (TW)

(73) Assignee: CHI MEI COMMUNICATION SYSTEMS, INC., Tu-Cheng (TW)

(21) Appl. No.: 13/480,487

(22) Filed: May 25, 2012

(30) Foreign Application Priority Data
Dec. 20, 2011 (TW) 100147554

(51) Int. Cl. H04W 48/16; H04B 7/26

(52) U.S. Cl. 455/41.2; 455/67.11

(57) ABSTRACT

In a method for monitoring a second mobile device using a first mobile device and wireless communication, a prompting file, a time interval, and a name of a second communication module of the second mobile device are set in the first mobile device. A first communication module of the first mobile device searches for discoverable devices within a predetermined coverage area of the first mobile device. Each found discoverable device is entered in a device list of the first mobile device. If the second communication module is found, a timer starts timing the time interval. After the time interval has elapsed, the first communication module searches for the discoverable devices again, for updating the device list. If the second communication module is not in the updated device list, the prompting file is outputted to alert a user of the first mobile device.

### BACKGROUND

1. Technical Field

Embodiments of the present disclosure relate to monitoring systems and methods using wireless communication, and more particularly to a monitoring system and method in a mobile device.

2. Description of Related Art

It is very important for adults to monitor children to avoid accidents or the children becoming lost. Most device-based monitoring methods use a wireless positioning system to monitor transmitter devices carried by the children. However, the wireless positioning system needs satellites to assist in positioning the devices carried by the children. If communication signals of the devices of the children are weak, it may not be possible to effectively monitor the children. Furthermore, the monitoring method using the wireless positioning system cannot provide a timely warning to the adult that the child has moved too far away from the adult.

### BRIEF DESCRIPTION OF THE DRAWINGS

FIG. 1 is a block diagram of one embodiment of a first mobile device that includes a monitoring system, also showing a second mobile device.

FIG. 2 is a block diagram of function modules of the monitoring system of the first mobile device of FIG. 1.

FIG. 3 is a flowchart of one embodiment of a method for monitoring the second mobile device by using the first mobile device of FIG. 1.

### DETAILED DESCRIPTION

The disclosure is illustrated by way of example and not by way of limitation in the figures of the accompanying drawings, in which like reference numerals indicate similar elements. It should be noted that references to “an” or “one” embodiment in this disclosure are not necessarily to the same embodiment, and such references can mean “at least one.”

In general, the word “module” as used herein refers to logic embodied in hardware or firmware, or to a collection of software instructions, written in a programming language, such as, Java, C, or assembly. One or more software instructions in the modules may be embedded in firmware, such as in an erasable-programmable read-only memory (EPROM). The modules described herein may be implemented as either software and/or hardware modules and may be stored in any type of non-transitory computer-readable medium or other storage device. Some non-limiting examples of non-transitory computer-readable media include compact discs (CDs), digital versatile discs (DVDs), Blu-ray disks, flash memory, and hard disk drives.

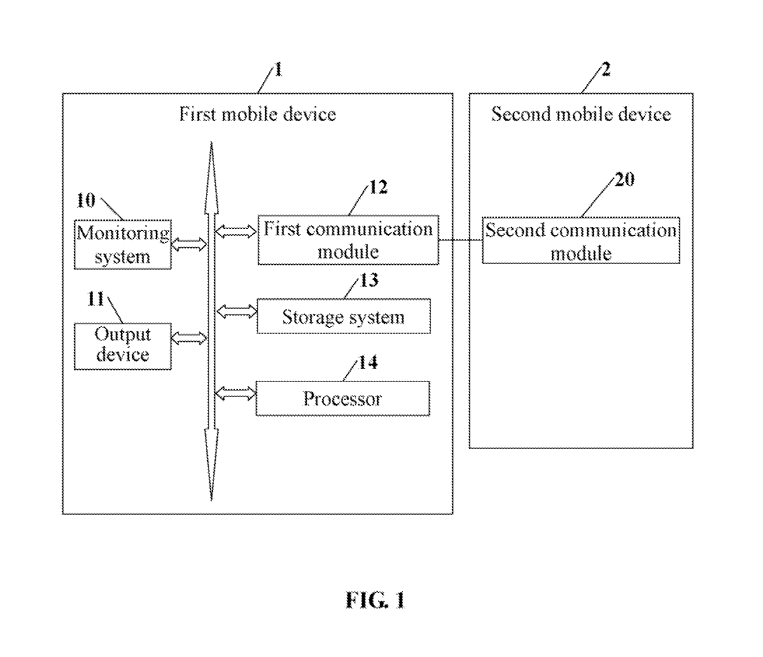

FIG. 1 is a block diagram of one embodiment of a first mobile device 1 that includes a monitoring system 10, also showing a second mobile device 2. The first mobile device 1 further includes an output device 11 and a first communication module 12. The first mobile device 1 may communicate with the second mobile device 2 through the first communication module 12 and a second communication module 20 in the second mobile device 2. Each of the first and second communication modules 12, 20 may be a Bluetooth™ module. In the embodiment, the first mobile device 1 is considered as a device for monitoring the second mobile device 2. For example, the first mobile device 1 is carried by a parent. The second mobile device 2 is considered as a device for being monitored by the first mobile device 1. For example, the second mobile device 2 is carried by a child. The monitoring system 10 may monitor the second mobile device 2 through the first communication module 12 and the second communication module 20, and provide prompting information to the user of the first mobile device 1. For example, the prompting information timely indicates that the second mobile device 2 has moved too far away from the first mobile device 1.

The output device 11 outputs data of the first mobile device 1 in one or more forms. In one embodiment, the output device 11 may include at least one of a display screen for outputting images and text of the data of the first mobile device 1, and a speaker for outputting the sound of audio files of the first mobile device 1. The first communication module 12 can search for discoverable communication modules (including the second communication module 20) within a predetermined coverage area of the first mobile device 1. The predetermined coverage area is defined according to the power of identification signals wirelessly broadcasted by each of the discoverable communication modules (including the second communication module 20). In this embodiment, the power of identification signals wirelessly broadcasted by all of the discoverable communication modules (including the second communication module 20) is substantially the same.

The predetermined coverage area can for example be within a radius of 10 meters of the first mobile device 1. This means the power of the identification signals broadcasted by each of the discoverable communication modules (e.g., the second communication module 20) is such that the first communication module 12 can detect the identification signals of a discoverable communication module (e.g., the second communication module 20) only if the discoverable communication module is within a radius of 10 meters of the first mobile device 1. In one embodiment, the second communication module 20 is always enabled (e.g., turned on) to be discoverable. Therefore, if a distance between the first mobile device 1 and the second mobile device 2 is within 10 meters, the first communication module 12 can detect (find) the second communication module 20.

In a further embodiment, the second communication module 20 can search for other discoverable communication modules (including the first communication module 12) within a predetermined coverage area of the second mobile device 2. In such case, the second mobile device 2 typically has substantially the same configuration and features as the first mobile device 1. According to the example described above, the predetermined coverage area of the second mobile device 2 is within a radius of 10 meters of the second mobile device 2.

The first mobile device 1 further includes a storage system 13 and at least one processor 14. The storage system 13 stores the data of the first mobile device 1. The storage system 13 may for example be a memory, or an external storage card such as a smart media card or a secure digital card. The at least one processor 14 executes one or more computerized codes and other applications for the first mobile device 1, to provide the functions of the monitoring system 10.

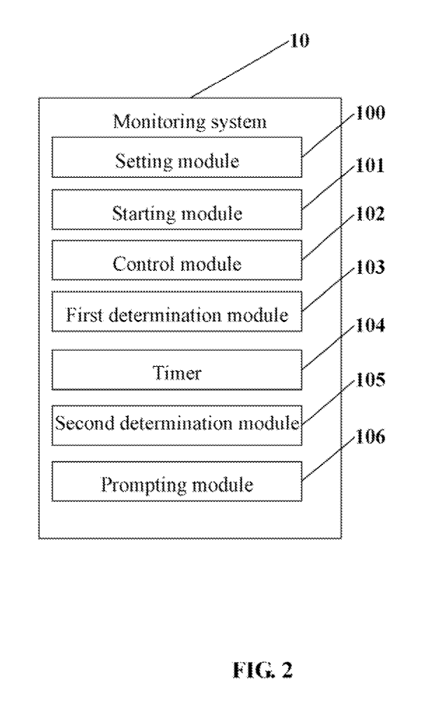

FIG. 2 is a block diagram of function modules of the monitoring system 10 of the mobile device 1. In the embodiment, the monitoring system 10 may include a setting module 100, a starting module 101, a control module 102, a first determination module 103, a timer 104, a second determination module 105, and a prompting module 106. The modules 100-106 comprise computerized codes in the form of one or more programs that may each be stored in the storage system 13. The computerized codes include instructions that are executed by the at least one processor 14 to provide functions for the modules 100-106. Details of these operations are described below.

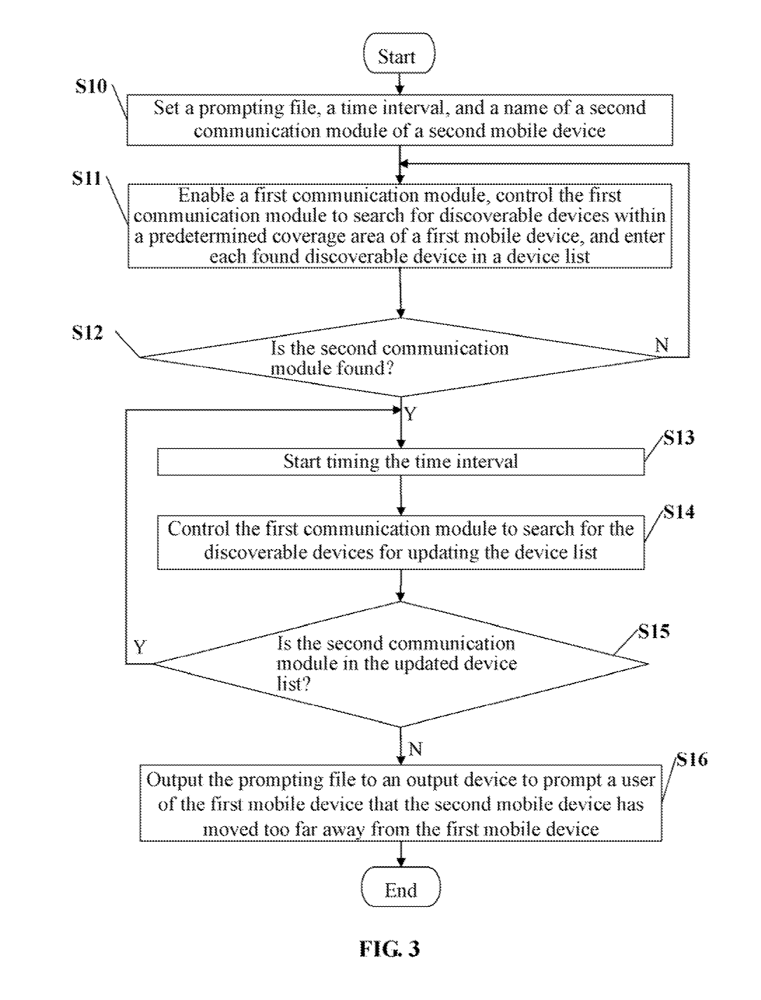

FIG. 3 is a flowchart of one embodiment of a method for monitoring the second mobile device 2 by using the first mobile device 1. Depending on the embodiment, additional steps may be added, others deleted, and the ordering of the steps may be changed.

In step S10, the setting module 100 sets a prompting file(s), a time interval for monitoring the second mobile device 2, and a name of the second communication module 20 of the second mobile device 2. The prompting file(s) may include at least one of a text file and an audio file, each of which includes suitable prompting content indicating that the second mobile device 2 has moved too far away from the first mobile device 1. In one embodiment, the text file may contain a message such as “The child is too far away,” and the audio file may contain speech such as “Warning, the child is too far away.” The time interval is used to regularly sample the environment of the first mobile device 1, and thereby periodically monitor the second mobile device 2 to determine whether the location of the second mobile device 2 remains within the coverage area of the first mobile device 1. The time interval can be 30 seconds, for example. In other embodiments, the setting module 100 may also set names of other communication modules of other mobile devices that need to be monitored.

In step S11, the starting module 101 enables the first communication module 12, and the control module 102 controls the first communication module 12 to search for one or more discoverable devices within the predetermined coverage area of the first mobile device 1. The search is one-shot, and may take about 5 seconds for example. In the embodiment, the one or more discoverable devices include at least the second communication module 20, which is always enabled (e.g., turned on) to be discoverable. If a discoverable device is detected by the first communication module 12, the name of the discoverable device is entered (i.e., registered or presented) in a device list of the first mobile device 1. The device list can for example be held in the storage system 13. Note that once the first communication module 12 is enabled, it remains enabled for the duration of the method.

In step S12, the first determination module 103 checks the device list to determine whether the second communication module 20 is found. In the embodiment, the first determination module 103 checks for the presence of the name of the second communication module 20 in the device list. In one example, the first determination module 103 finds the name of the second communication module 20 in the device list, and so determines that the second communication module 20 is found. If the second communication module 20 is found, step S13 is implemented. If the second communication module 20 is not found, the procedure returns to step S11.

In step S13, the timer 104 starts timing the time interval.

In step S14, when the time interval has elapsed, the control module 102 controls the first communication module 12 to search for the discoverable devices within the predetermined coverage area of the first mobile device 1, for updating the device list. The search is one-shot, and may take about 5 seconds for example.

In step S15, the second determination module 105 determines whether the second communication module 20 is in the updated device list. If the second communication module 20 is in the updated device list, the procedure returns to step S13. If the second communication module 20 is found to be absent from the updated device list, step S16 is implemented.

In step S16, the prompting module 106 outputs the prompting file(s) to the output device 11, for prompting the user of the first mobile device 1 that the second mobile device 2 has moved too far away from the first mobile device 1.

In applications such as a parent wanting to prevent a child from becoming lost, the monitoring system 10 can also be included in the second mobile device 2. The setting module 100 may set a name of the first communication module 12 of the first mobile device 1, and set a prompting file(s). The prompting file(s) may include suitable prompting content which warns the user of the second mobile device 2, i.e. the child, to stop and wait and not move further. If the first communication module 12 is not found in the updated device list of the second mobile device 2, the prompting module 106 outputs the prompting file(s) to the output device 11 for prompting the child.

All of the processes described above may be embodied in, and fully automated via, functional code modules executed by one or more general purpose processors such as the processor 14. The code modules may be stored in any type of non-transitory readable medium or other storage device, such as the storage system 13. Some or all of the methods may alternatively be embodied in specialized hardware. Depending on the embodiment, the non-transitory readable medium may be a hard disk drive, a compact disc, a digital versatile disc, a tape drive, or other suitable storage medium.

The described embodiments are merely examples of implementations, and have been set forth for a clear understanding of the principles of the present disclosure. Variations and modifications may be made without departing substantially from the spirit and principles of the present disclosure. All such modifications and variations are intended to be included within the scope of this disclosure and the described inventive embodiments, and the present disclosure is protected by the following claims and their equivalents.

What is claimed is:

1. A method for wirelessly monitoring a second mobile device using a first mobile device, the method comprising:
setting at least one prompting file for prompting a user of the first mobile device, a time interval for monitoring the second mobile device, and a name of a second communication module of the second mobile device;
enabling a first communication module of the first mobile device, and controlling the first communication module to search for one or more discoverable devices within a predetermined coverage area of the first mobile device;
entering a name of each found discoverable device in a device list of the first mobile device;
determining whether the second communication module is found according to the presence or absence of the name of the second communication module in the device list;
starting timing the time interval, if the second communication module is found;
controlling the first communication module to search for the discoverable devices within the predetermined coverage area after the time interval has elapsed, in order to update the device list;
determining whether the second communication module is in the updated device list; and
outputting the at least one prompting file using an output device of the first mobile device for prompting the user that the second mobile device has moved too far away from the first mobile device, if the second communication module is found to be absent from the updated device list.

2. The method according to claim 1, wherein the first communication module is a first Bluetooth™ module and the second communication module is a second Bluetooth™ module.

3. The method according to claim 1, wherein the at least one prompting file comprises at least one of a text file and an audio file.

4. The method according to claim 1, wherein the output device comprises at least one of a display screen and a speaker.

5. The method according to claim 1, wherein the second communication module is always enabled to be discoverable.

6. The method according to claim 1, further comprising:
starting timing the time interval once again, if the second communication module is in the updated device list.

7. A non-transitory storage medium storing a set of instructions, the set of instructions capable of being executed by a first mobile device to cause the first mobile device to perform a method for wirelessly monitoring a second mobile device, the method comprising:
setting at least one prompting file for prompting a user of the first mobile device, a time interval for monitoring the second mobile device, and a name of a second communication module of the second mobile device;
enabling a first communication module of the first mobile device, and controlling the first communication module to search for one or more discoverable devices within a predetermined coverage area of the first mobile device;
entering a name of each found discoverable device in a device list of the first mobile device;
determining whether the second communication module is found according to the presence or absence of the name of the second communication module in the device list;
starting timing the time interval, if the second communication module is found;
controlling the first communication module to search for the discoverable devices within the predetermined coverage area after the time interval has elapsed, in order to update the device list;
determining whether the second communication module is in the updated device list; and
outputting the at least one prompting file using an output device of the first mobile device for prompting the user that the second mobile device has moved too far away from the first mobile device, if the second communication module is found to be absent from the updated device list.

8. The non-transitory storage medium according to claim 7, wherein the first communication module is a first Bluetooth™ module and the second communication module is a second Bluetooth™ module.

9. The non-transitory storage medium according to claim 7, wherein the at least one prompting file comprises at least one of a text file and an audio file.

10. The non-transitory storage medium according to claim 7, wherein the output device comprises at least one of a display screen and a speaker.

11. The non-transitory storage medium according to claim 7, wherein the second communication module is always enabled to be discoverable.

12. The non-transitory storage medium according to claim 7, wherein the method further comprises:
starting timing the time interval once again, if the second communication module is in the updated device list.

13. A mobile device, comprising:
a first communication module;
a storage system;
at least one processor;
an output device; and
one or more programs that are stored in the storage system and executed by the at least one processor, the one or more programs comprising:
a setting module that sets at least one prompting file for prompting a user of the mobile device, a time interval for monitoring a second mobile device, and a name of a second communication module of the second mobile device;
a starting module that enables the first communication module;
a control module that controls the first communication module to search for one or more wirelessly discoverable devices within a predetermined coverage area of the mobile device, and enters a name of each found discoverable device in a device list of the mobile device;
a first determination module that determines whether the second communication module is found according to the presence or absence of the name of the second communication module in the device list;
a timer that starts timing the time interval;
a second determination module; and
an output module;
wherein the control module also controls the first communication module to search for the discoverable devices within the predetermined coverage area in order to update the device list, when the time interval has elapsed;
the second determination module determines whether the second communication module is in the updated device list; and
the output module outputs the at least one prompting file using the output device for prompting the user that the second mobile device has moved too far away from the mobile device, if the second communication module is found to be absent from the updated device list.

14. The mobile device according to claim 13, wherein the first communication module is a first Bluetooth™ module and the second communication module is a second Bluetooth™ module.

15. The mobile device according to claim 13, wherein the at least one prompting file comprises at least one of a text file and an audio file.

16. The mobile device according to claim 13, wherein the output device comprises at least one of a display screen and a speaker.

17. The mobile device according to claim 13, wherein the second communication module is always enabled to be discoverable.
